(19) United States
(12) Patent Application Publication
(10) Pub. No.: US 2018/0285990 A1
(43) Pub. Date: Oct. 4, 2018

(54) SYSTEM AND METHOD FOR CHARTERING FLIGHTS

(71) Applicant: Joel Relova, Jacksonville, FL (US)

(72) Inventor: Joel Relova, Jacksonville, FL (US)

(21) Appl. No.: 15/474,765

(22) Filed: Mar. 30, 2017

(51) Int. Cl. G06Q 50/14; G06Q 10/02; G06Q 50/00

(52) U.S. Cl. CPC G06Q 50/14; G06Q 50/01; G06Q 10/02

(57) ABSTRACT

Embodiments presented include system and method of chartering flights, the system comprising a memory unit and a processor. The memory unit to store a database comprising one or more records associated with at least one user, and a set of program modules. A set of potential companion travellers are connected to the at least one user via the at least one social media platform. The companion selection module, receives from the potential companion, at least one of a confirmation message and a rejection message to join the at least one user, and add the at least one potential companion into a set of travel companions, based on the confirmation message being received from the at least one potential companion. An output module, presents the at least one user with the set of travel companions, and record booking of the at least one flight by the at least one user.

### FIELD

The present embodiment relates to technical field of mobile applications, and in particular, to mobile application based system and method of chartering flights.

### BACKGROUND

On-demand mobile applications have pervaded every aspect of life in the twenty first century. Examples of the on-demand mobile applications include but are not limited to Repair Pal, Uber, and Showaround. Today, users access the on-demand mobile applications for multiple purposes. As often is the case, users access the on-demand mobile applications to buy flight tickets, train tickets, bus tickets. Also, the users access the on-demand mobile applications to rent cars, buses and trucks.

In an existing system, an on-demand mobile application enables a user to charter private flights. The on-demand mobile application provides user with ability to request for private chartered flight from a network of flight operators. The on-demand mobile application automates process of submitting user's request to available flight operators, and automates process of accepting bids from a plurality of participating flight operators, booking the flight and processing payment. In addition, the on-demand mobile application provides the users with options to share the trip with other people, thereby making ordeal of chartering flights affordable and convenient. Further, the on-demand mobile application enables the users to find like-minded people to share journeys and split costs with.

However, existing systems fail to integrate process of chartering the flights with one or more social media platforms. The users lack the ability to invite one or more of the user's social media contacts to share the flight and thereby defray cost of the flight. The existing systems fail to facilitate one or more payment transactions involved in chartering flights. Moreover, existing systems fail to facilitate payment process to divide total cost of the journey amongst all the people using the flight. Furthermore, the existing system fail to externalize process of sharing the flight to other people within the social media platform of the users, with integration methods with the one or more social medial platforms. Moreover, in existing systems, the users lack ability to choose one of a committed flight share and a non-committed flight share. Thus, in existing systems, the users lack ability to automate process of socialization, invitation and booking.

Although there are several prior art references to mobile applications and web applications for chartering flights, there is not a single prior art reference that discloses a customized flight chartering system capable of integrating one or more social media platforms.

### SUMMARY OF THE INVENTION

Embodiments described herein include a system and method for chartering flights. The system for chartering flights comprises a memory unit and a processor. The memory unit stores a database comprising one or more records associated with at least one user, and a set of program modules. The one or more records comprise details regarding at least one flight booked by the at least one user, capacity of the at least one flight, and details regarding at least one social media platform used by the user. The set of program modules comprises an input module, a companion selection module, and an output module. The input module, executed by the processor, is configured to receive contact details of a set of potential companion travellers from the at least one social media platform, wherein the set of potential companion travellers are connected to the at least one user via the at least one social media platform. The companion selection module, requests at least one potential companion among the set of potential companions to join the at least one user on a journey in the at least one flight, receive from the at least one potential companion, at least one of a confirmation message and a rejection message to join the at least one user, and add the at least one potential companion into a set of travel companions, based on the confirmation message being received from the at least one potential companion. The output module, executed by the processor, configured to present the at least one user with the set of travel companions, and record booking of the at least one flight by the at least one user.

In one embodiment of the present invention, the companion selection module is further configured to compare number of people in the set of travel companions with the flight capacity of the at least one flight, and record booking of the at least one flight based on the number of people in the set of travel companions being equal to the flight capacity. The details regarding the at least one flight comprises time of arrival of the at least one flight, time of departure of the at least one flight, source airport of the at least one flight, and destination airport of the at least one flight. The social media platform is at least one of a travel based social media platform, a recreational social media platform, a forum based social media platform, and a professional social media platform. The companion selection module requests the at least one potential companion via at least one of an email, a phone call, and a text message. The output module presents the at least one user with the set of travel companions via at least one of a laptop, a tablet computer, and a personal computer.

In one embodiment of the present invention, the method comprises storing in a memory unit, a database comprising one or more records associated with at least one user. The one or more records comprise details regarding at least one flight booked by the at least one user, capacity of the at least one flight, and details regarding at least one social media platform used by the user. Further, the method comprises receiving by a processor, via an input module, contact details of a set of potential companion travellers from the at least one social media platform. The set of potential companion travellers are connected to the at least one user via the at least one social media platform. Further, the method comprises requesting by the processor, via a companion selection module, at least one potential companion among the set of potential companions to join the at least one user on a journey in the at least one flight. Furthermore, the method comprises receiving by the processor, via the companion selection module, from the at least one potential companion, at least one of a confirmation message and a rejection message to join the at least one user, and adding by the processor, via the companion selection module the at least one potential companion into a set of travel companions, based on the confirmation message being received from the at least one potential companion. Moreover, the method comprises presenting, by the processor via an output module, the at least one user with the set of travel companions, and recording by the processor via the output module, booking of the at least one flight by the at least one user.

Other aspects, advantages, and novel features of the present invention will become apparent from the following detailed description in conjunction with the drawings.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a block diagram of an environment implemented in accordance with various embodiments of the invention.

FIG. 2 is a block diagram of a system for chartering a flight in accordance with various embodiments of the invention.

FIG. 3 is flow chart of a computer-implemented method of chartering a flight, according to yet another embodiment of the present invention.

FIG. 4 is an exemplary illustration of a screenshot of a mobile application configured to receive one or more details from the user, in accordance with one embodiment of the present invention.

FIG. 5 is an exemplary illustration of a screenshot of a mobile application configured to receive one or more detail regarding a flight, from a user, in accordance with one embodiment of the present invention.

FIG. 6 is an exemplary illustration of a screenshot of a mobile application configured to receive an instruction to book the flight as one of a private flight, a committed flight share and a non-committed flight share, from a user, in accordance with one embodiment of the present invention.

FIG. 7 is an exemplary illustration of a screenshot of a mobile application configured to notify a user about a received request, in accordance with one embodiment of the present invention.

FIG. 8 is an exemplary illustration of a screenshot of a mobile application configured to notify a user about a received request being successful, in accordance with one embodiment of the present invention.

FIG. 9 is an exemplary illustration of a screenshot of a mobile application configured to engage a flight operator in a bidding process, in accordance with one embodiment of the present invention.

FIG. 10 is an exemplary illustration of a screenshot of a mobile application configured to notify a user of a bid, in accordance with one embodiment of the present invention.

FIG. 11 is an exemplary illustration of a screenshot of summary screen, in accordance with one embodiment of the present invention.

FIG. 12 is an exemplary illustration of a screenshot of trip details screen, in accordance with one embodiment of the present invention.

FIG. 13 is an exemplary illustration of a screenshot of additional details, in accordance with one embodiment of the present invention.

FIG. 14 is an exemplary illustration of a screenshot of a payment screen, in accordance with one embodiment of the present invention.

FIGS. 15a, 15b, 15c, and 15d are exemplary illustrations of screenshots of contract agreement a user is required to sign prior to booking the flight, in accordance with one embodiment of the present invention.

FIG. 16 is an exemplary illustration of a screenshot of “make payment” page, in accordance with one embodiment of the present invention.

FIG. 17 is an exemplary illustration of a screenshot of confirmation screen for trip, in accordance with one embodiment of the present invention.

FIG. 18 is an exemplary illustration of a screenshot of settings page for a committed flight share, in accordance with one embodiment of the present invention.

FIG. 19 is an exemplary illustration of a screenshot of socializing page, in accordance with one embodiment of the present invention.

FIG. 20 is an exemplary illustration of a screenshot of another socializing page, in accordance with one embodiment of the present invention.

FIG. 21 is an exemplary illustration of a screenshot of FACEBOOK™ integration, in accordance with one embodiment of the present invention.

FIG. 22 is an exemplary illustration of a screenshot of SMS integration, in accordance with one embodiment of the present invention.

FIG. 23 is an exemplary illustration of another screenshot of social media integration, in accordance with one embodiment of the present invention.

FIG. 24 is an exemplary illustration of yet another screenshot of social media integration, in accordance with one embodiment of the present invention.

FIG. 25 is an exemplary illustration of a rules page, in accordance with one embodiment of the present invention.

FIG. 26 is an exemplary illustration of a confirmation page, in accordance with one embodiment of the present invention.

FIG. 27 is an exemplary illustration of a notification page, in accordance with one embodiment of the present invention.

FIG. 28 is an exemplary illustration of a waitlist page, in accordance with one embodiment of the present invention.

### DETAILED DESCRIPTION

The specific details of the single embodiment or variety of embodiments described herein are set forth in this application. Any specific details of the embodiments are used for demonstration purposes only and no unnecessary limitations or inferences are to be understood therefrom.

The present invention integrates process of chartering the flights with one or more social media platforms. The users are enabled to invite one or more of the user's social media contacts to share the flight and thereby defray cost of the flight. The present invention is implemented using a smartphone based mobile application to facilitate one or more payment transactions involved in chartering flights. The present invention also facilitates payment process to divide total cost of the journey amongst all the people using the flight. The present invention externalizes process of sharing the flight to other people within the social media platform of the users, with integration methods with the one or more social medial platforms. Further, the users are enabled to choose one of a committed flight share and a non-committed flight share. In a committed flight sharing scenario, the users opt to indicate number of people required to join the users on the journey does not proceed to booking the flight unless the indicated number of people are willing to join the user on the journey. In an uncommitted Flight-Share scenario, the users opt to proceed to reserving and booking the chartered flight regardless whether the chartered flight is shared or not shared with anyone else. In the uncommitted flight share scenario, the users are responsible for the chartered flight. The present invention enables the users to automate process of socialization, invitation and booking and facilitates the sharing of the cost of the chartered flight. In one example, a person who accepts invitation of the users to join the user on the user's journey is referred to as a Trip Rider. The users are enabled to either accept or reject the trip rider's entry into the flight.

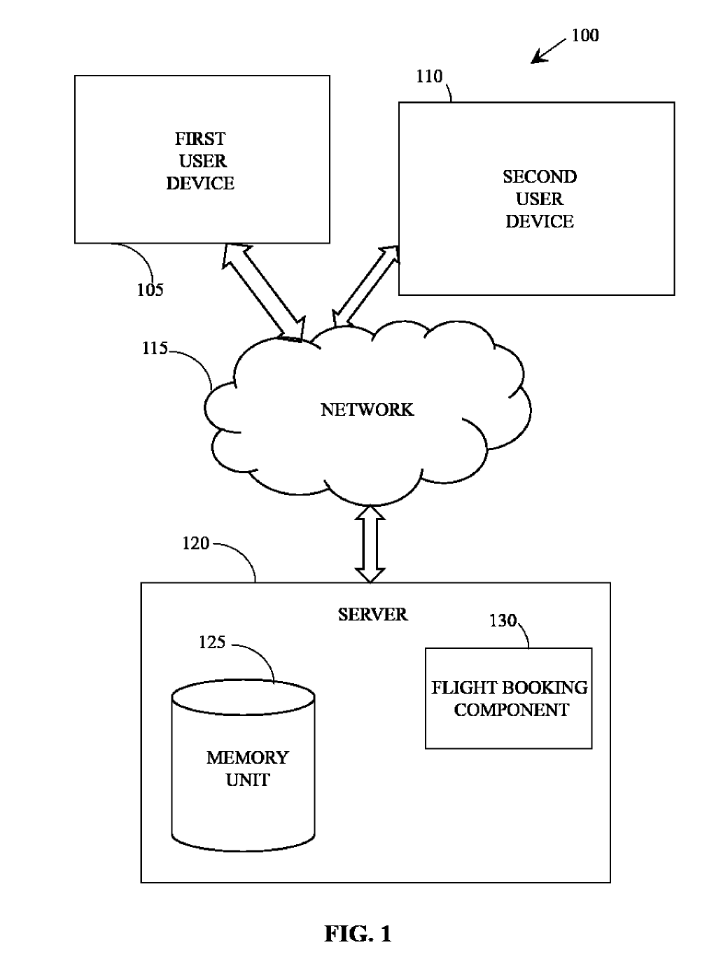

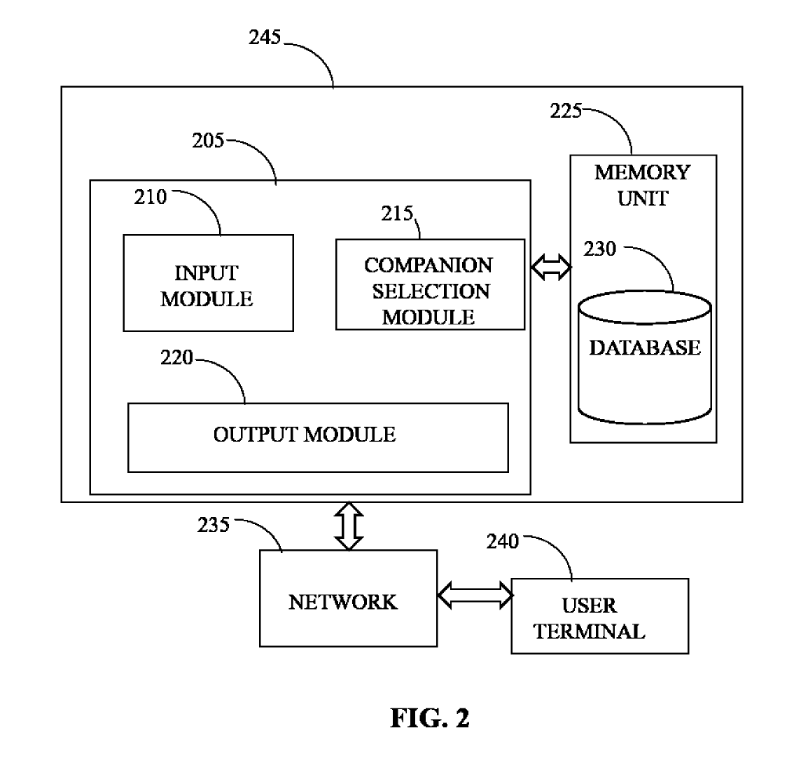

FIG. 1 is a block diagram of an environment 100 in accordance with which various embodiments of the present invention are implemented. The environment 100 comprises a first user device 105, a second user device 110, a network 115, and a server 120. The first user device 105 and the second user device 110 are at least one of tablet computers, personal computers, smart phones, smart televisions and laptops. In one embodiment of the present invention, the first user device 105 and the second user device 110 comprises a Global Positioning System (not shown here). In one example, the first user device 105 enables a user to communicate with the server 120 via the network 115. The second user device 110 enables the workout buddy to communicate with the server 120 via the network 115. The first user device 105 and the second user device 110 are at least one of laptops, personal computers, smart phones, smart televisions, and tablet computers. The server 120 comprises a memory unit 125 and a flight booking component 130. A block diagram of an exemplary implementation of the flight booking component 130 is illustrated in FIG. 2. In one embodiment, the present invention is implemented as an on-demand mobile application, a web application, and a website.

Referring to FIG. 2, a flight booking component 205 is implemented inside a device 245 connected to a network 235. In one embodiment of the present invention, the device 245 is a server. In another embodiment of the present invention, the device 245 is at least one of a laptop, a personal computer, a smart phone, a smart television, and a tablet computer. The network 235 is at least one of a Local Area Network, a Wide Area Network, a Wireless Network, a telecommunication network, a mobile network, and an Internet. The network 235 enables the user to communicate with the device 245. The user is connected to the network 235 via a user terminal 240. The user terminal 240 is at least one of a laptop, a personal computer, a smart phone, a smart television, and a tablet computer. The user terminal 240 comprises a global positioning system (not shown).

Further, the device 245 comprises a memory unit 225 and the flight booking component 205. The flight booking component 205 is hereafter referred to as a processor. The memory unit 225 is at least one of a volatile memory, non-volatile memory, Read Only memory (ROM), Random Access Memory (RAM), and a flash memory. The memory unit 225 comprises a database 230 comprising one or more records.

In one embodiment of the present invention, the memory unit 225 stores a database 230 comprising one or more records associated with at least one user, and a set of program modules. The one or more records comprise details regarding at least one flight booked by the at least one user, capacity of the at least one flight, and details regarding at least one social media platform used by the user. The details regarding the at least one flight comprises time of arrival of the at least one flight, time of departure of the at least one flight, source airport of the at least one flight, and destination airport of the at least one flight. The social media platform is at least one of a travel based social media platform, a recreational social media platform, a forum based social media platform, and a professional social media platform. In one example, the system receives the details regarding the at least one flight via at least one of a mobile application, and a website.

The set of program modules comprises an input module 210, a companion selection module 215, and an output module 220. The input module 210, executed by the processor, is configured to receive contact details of a set of potential companion travellers from the at least one social media platform, wherein the set of potential companion travellers are connected to the at least one user via the at least one social media platform.

The companion selection module 215, requests at least one potential companion among the set of potential companions to join the at least one user on a journey in the at least one flight, receive from the at least one potential companion, at least one of a confirmation message and a rejection message to join the at least one user, and add the at least one potential companion into a set of travel companions, based on the confirmation message being received from the at least one potential companion. In one embodiment of the present invention, the companion selection module 215 is further configured to compare number of people in the set of travel companions with the flight capacity of the at least one flight, and record booking of the at least one flight based on the number of people in the set of travel companions being equal to the flight capacity. The companion selection module 215 requests the at least one potential companion via at least one of an email, a phone call, and a text message.

The output module 220, executed by the processor, is configured to present the at least one user with the set of travel companions, and record booking of the at least one flight by the at least one user. The output module 220 presents the at least one user with the set of travel companions via at least one of a laptop, a tablet computer, and a personal computer.

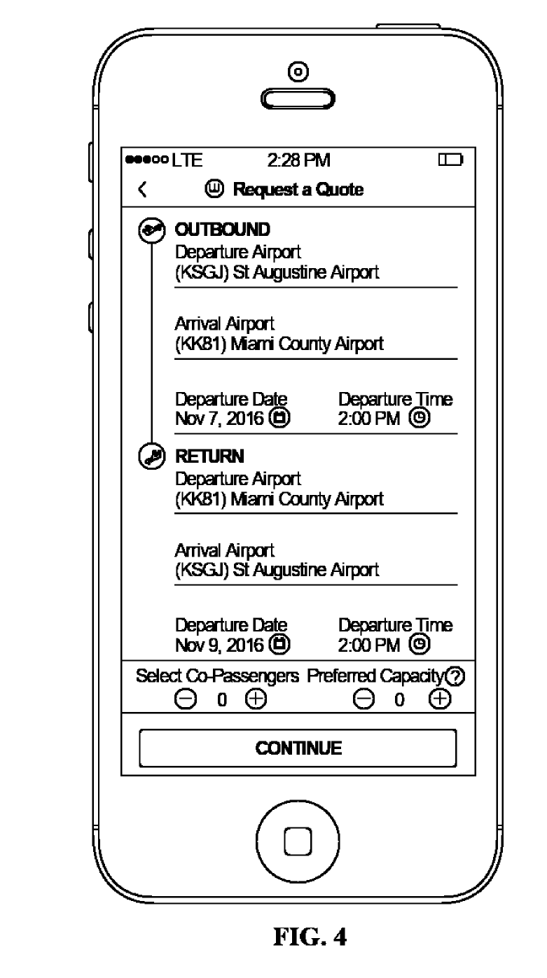

Referring to FIG. 4, an exemplary illustration of a screenshot of a mobile application configured to receive one or more details from the user, in accordance with one embodiment of the present invention. In one example, the user is enabled to enter departure airport information and arrival airport information. Further, the user is enabled to search different airports. In one example, the present invention uses at least one search engine for searching. In one example, if a user requests a quote for the flight, then the information regarding the request is displayed in a Trip Request tab.

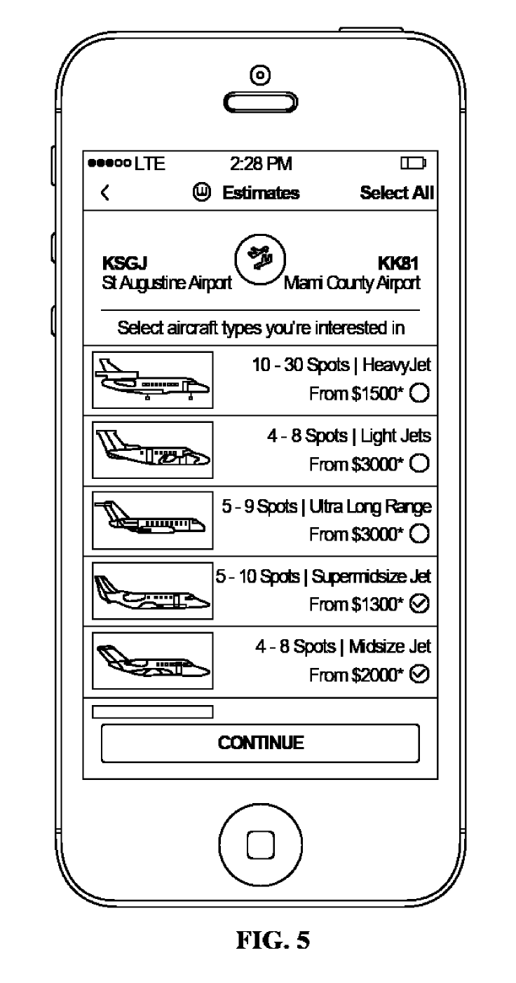

Referring to FIG. 5, an exemplary illustration of a screenshot of a mobile application configured to receive one or more detail regarding a flight, from a user, in accordance with one embodiment of the present invention. The user is enabled to select from a list the type of aircraft that the user wishes to fly on.

In one example, the user is enabled to tap a “Respond to request” button. After the user taps the “respond to request” button, a flight operator is enabled to add aircrafts available to the user along with price and total time for flight operators can add multiple aircrafts for the quote, if available. After adding aircrafts, the flight operator can submit a quote and the request will be moved on to an “Others Tab” successfully. There are three types of requests: an expired request, a request waiting for approval, and a rejected request. The expired request is the request on which no action was performed by the flight operator within 12 hours of generation of the request. The request waiting for approval is a request on which response was given by the flight operator but no action was taken by the user. The rejected request is a request which is rejected.

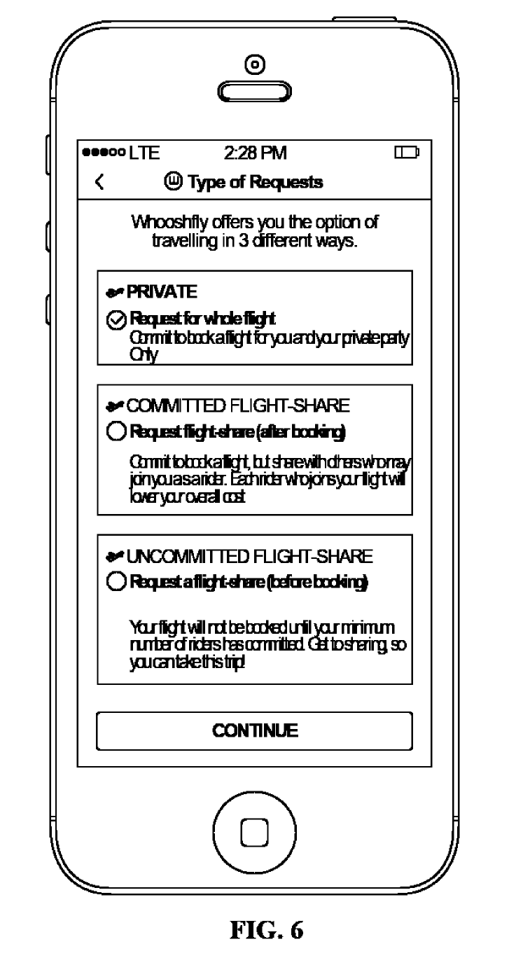

Referring to FIG. 6, an exemplary illustration of a screenshot of a mobile application configured to receive an instruction to book the flight as one of a private flight, a committed flight share and a non-committed flight share, from a user, in accordance with one embodiment of the present invention. After the user enters the user's selection, the user is enabled to select one of the private flight, a committed flight share and a non-committed flight share. In the private flight, the user reserves the flight for himself. In the committed flight share, the user reserves the flight for the user, but a flight booking component helps the user in finding other individuals from at least one social media platform to share the flight with. In the committed flight share, the user reserves the private charter flight only if total number of people with whom the user is willing to share the flight with is met. In one example, the user is enabled to enter the number of passengers, the user wants to travel with and preferred capacity of a flight. The user is enabled to bid a Quote for the flight the present invention redirects the user to a “Get estimates” screen. Pricing and aircraft categories are shown to the user on basis of the preferred capacity and range/distance between the Departure airport and the arrival airport.

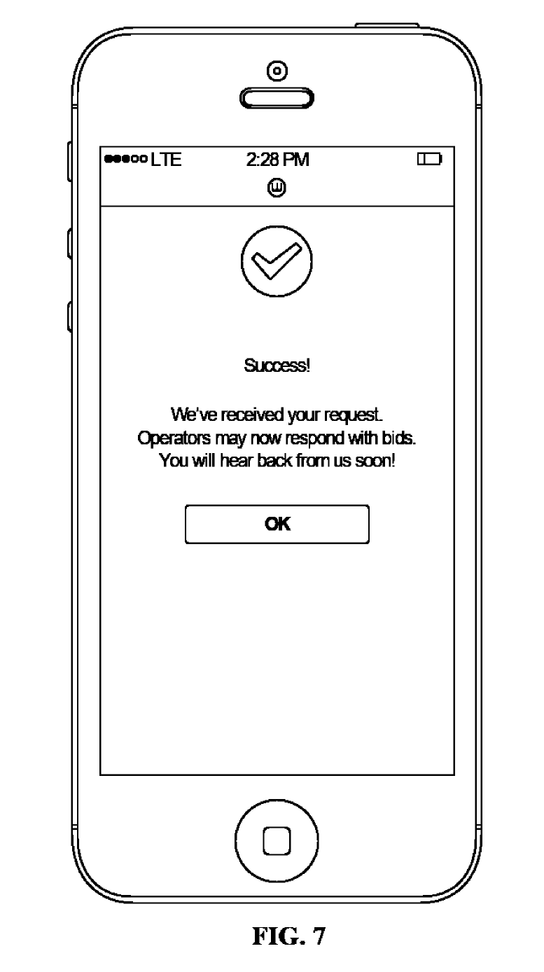

Referring to FIG. 7, an exemplary illustration of a screenshot of a mobile application configured to notify a user about a received request, in accordance with one embodiment of the present invention. Upon successful submission of a request, the present invention will confirm that the request has been submitted. Otherwise, if there are no operators in the area, the system will alert the Administrator of the platform.

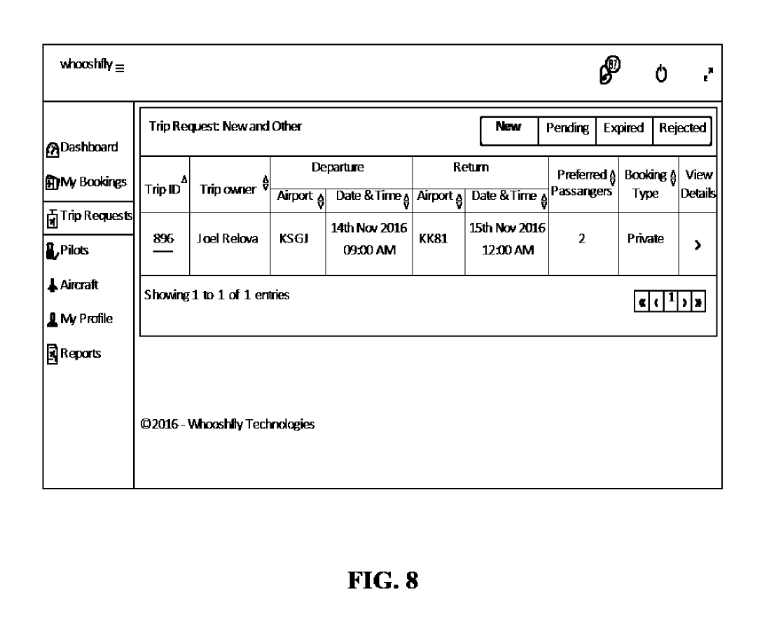

Referring to FIG. 8, an exemplary illustration of a screenshot of a mobile application configured to notify a user about a received request being successful, in accordance with one embodiment of the present invention. When submission of request is successful, a flight operator in the area of departure will receive a request for a bid from the system.

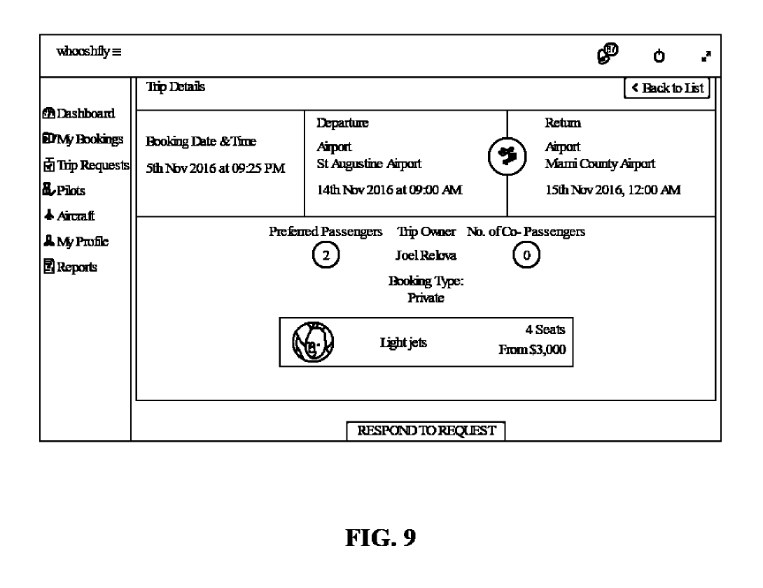

Referring to FIG. 9, an exemplary illustration of a screenshot of a mobile application configured to engage a flight operator in a bidding process, in accordance with one embodiment of the present invention. The flight operator receives a request for a bid from a user. The flight operator is enabled to enter a bid. In a bidding process, the flight operator is enabled to enter plane description, price and other details of the plane and trip. The flight operator will have 24 hours to enter the bid. In another example, the flight operator has time until the user accepts another bid.

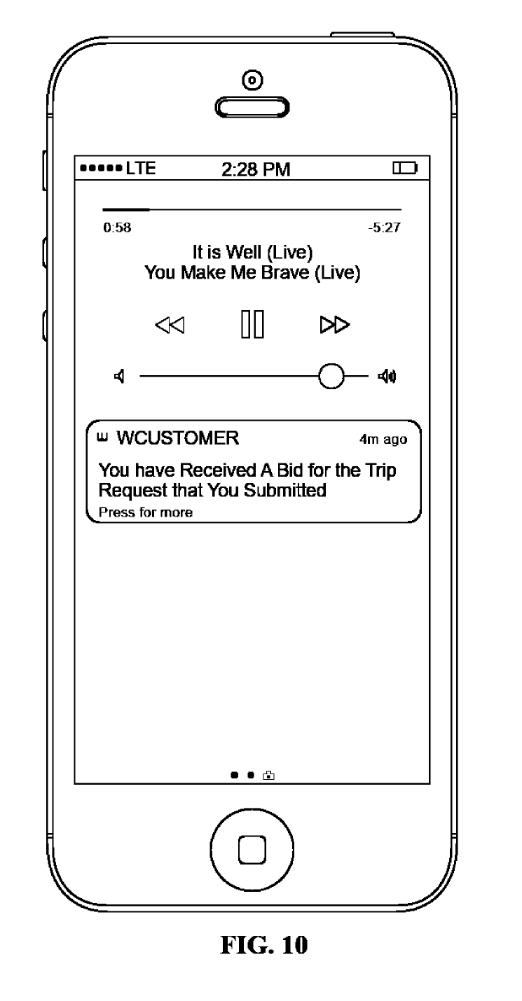

Referring to FIG. 10, an exemplary illustration of a screenshot of a mobile application configured to notify a user of a bid, in accordance with one embodiment of the present invention. After a flight operator submits a bid, the user will be notified by the present invention. The user can view the bid through Trip quotes tab. Multiple bids for same request can be viewed by the user. The flight operators are enabled to submit bids for multiple aircrafts to the user. When the user clicks on name of the flight operator, then the flight operator can view list of bids from the flight operator. The user can select a particular bid response to view Bid details. Further, the user needs to enter passenger details the user shall be travelling with. In one example, after entering the passenger details, the user can see payment summary where Trip amount and other details will be there. Tax is 7.5% and Booking fee is 5% of Trip Amount. On submitting, the user needs to read formal contract and then has to sign the contract to book the flight.

In an exemplary illustration of working of the present invention, the flight operator will receive a push notification that “the user has accepted your quote.”. The flight operator can either click on notification and lead to Sign contract screen or can view the request in “To Be assigned” tab. Further, the flight operator needs to sign the contract within 12 hours then assign a pilot. If the flight operator will not sign the contract within 12 hours, then after 12 hours' notification will be sent to the user to choose another bid. If the flight operator signs, then the flight operator will assign the pilot and confirm the booking. Now the booking gets moved to a “Scheduled” tab. The user will get a push notification of the flight operator confirming the trip and can view in “My trips”. As the flight operator assigns the pilot, the pilot will get the notification and that particular trip will be displayed in “My flights” tab. Clicking on the push notification, pilot will be assigned to a “Flight details” screen. The pilot has the option to decline the flight. The request is saved as reminder in the calendar of phone. There will be two reminders: 45 minutes and 3 hours before the trip. On 3 hrs. reminder pilot, will see the Confirm/Decline screen where he must confirm or decline the flight if he would be flying today. On 45 minutes before the flight, the pilot will see a confirm passenger screen. The pilot must confirm the passengers on board by swiping left on particular passenger and decline the passenger by swiping right. If the pilot will not confirm the user, then the pilot will not be able to proceed further.

After confirming passengers, the pilot will see a Start trip screen with confirmed passengers list. The confirmed passengers will be shown as “ONBOARD” in “Scheduled tab” of the flight operator. Later, the pilot is enabled to access a “ratings screen” and the pilot is enabled to rate the passengers.

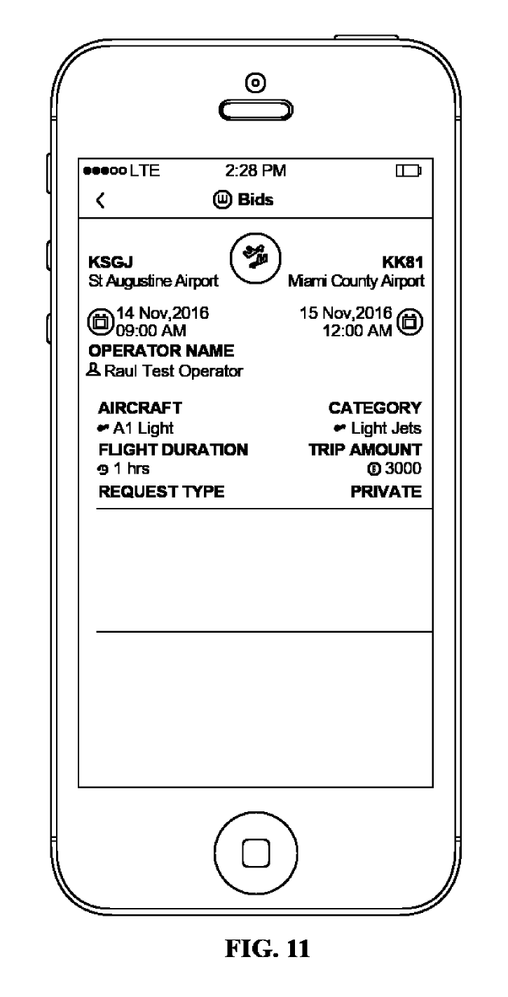

Referring to FIG. 11, an exemplary illustration of a screenshot of summary screen, in accordance with one embodiment of the present invention. When a user taps on notification that a bid for the user's request has been submitted, the present invention will takes the user to the summary screen

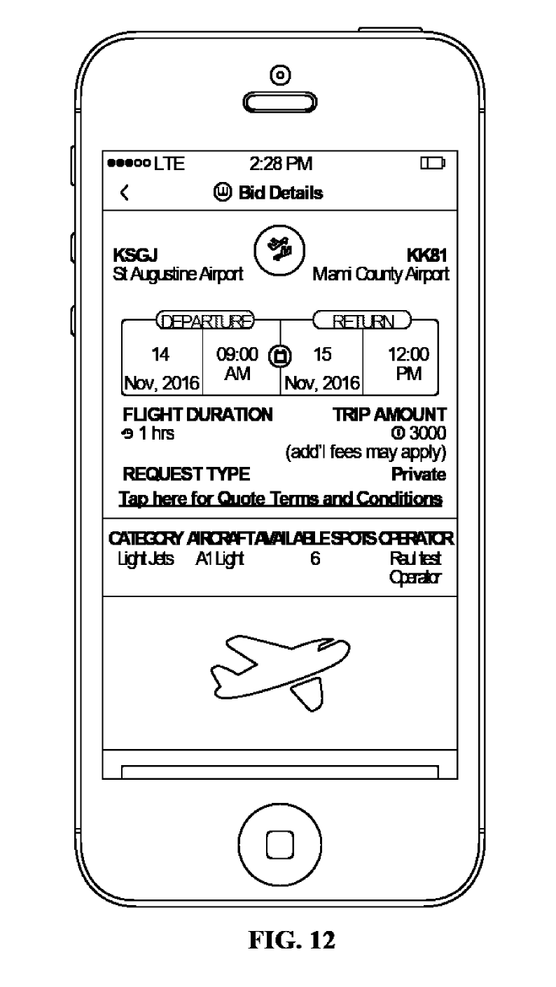

Referring to FIG. 12, an exemplary illustration of a screenshot of trip details screen, in accordance with one embodiment of the present invention. The user can look at details of each bid by tapping on a screen of a smartphone on a specific bid the user wants to review in detail. The details comprise total cost of the flight, duration of the flight, other terms and conditions of the flight, details of the plane and picture of the plane.

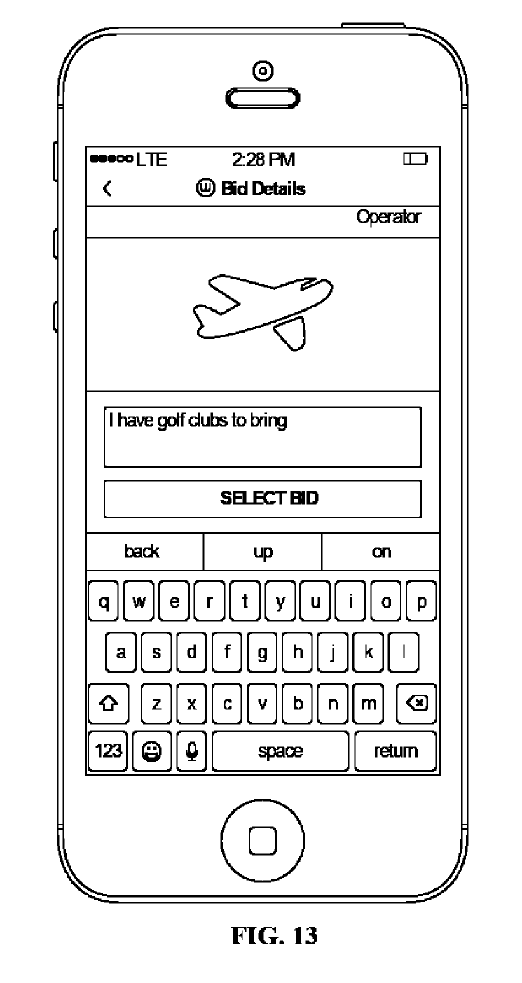

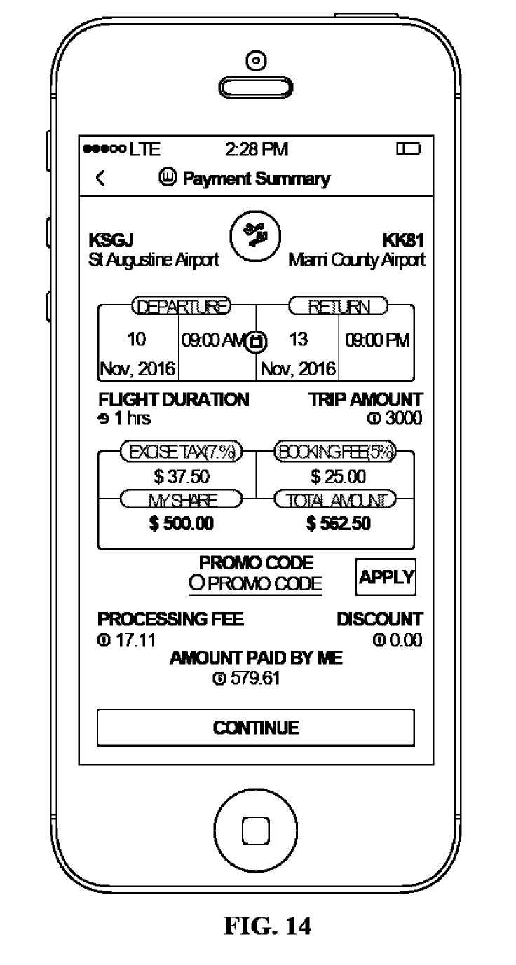

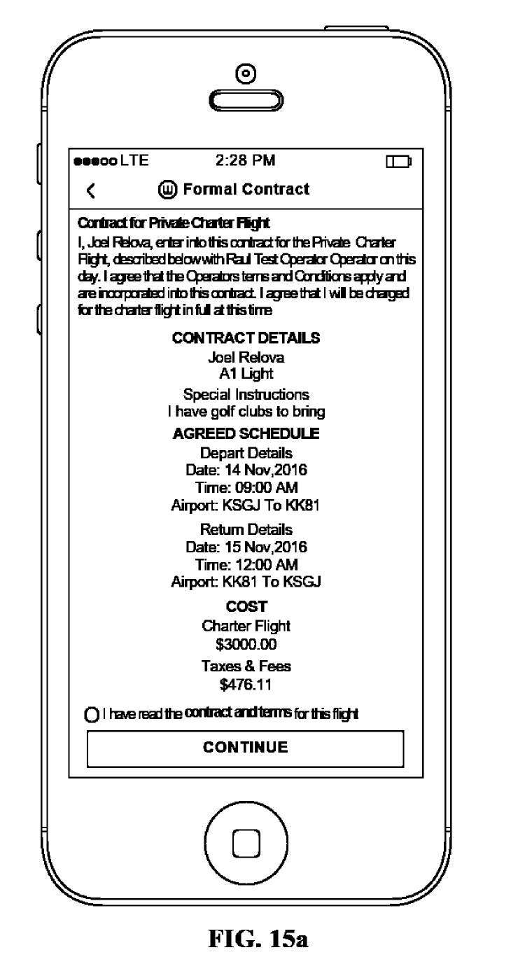

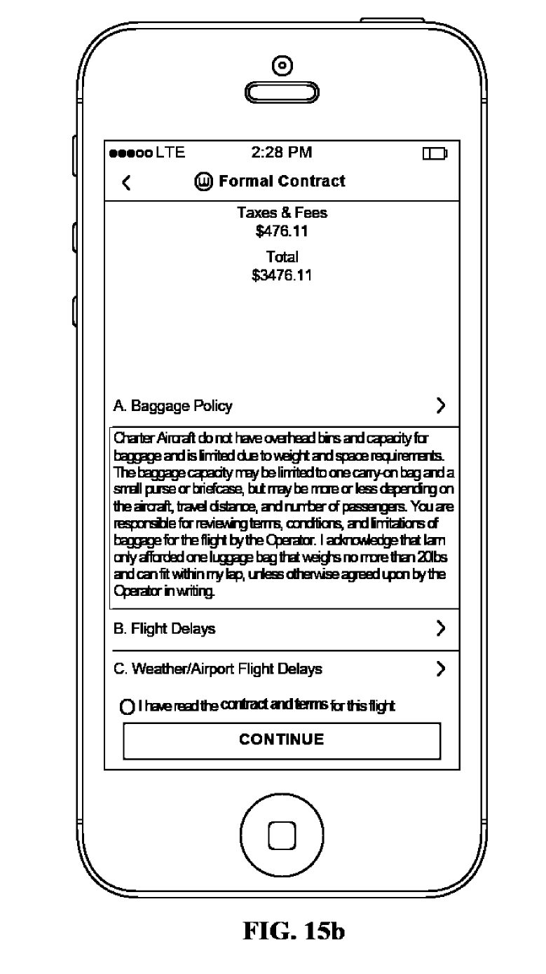

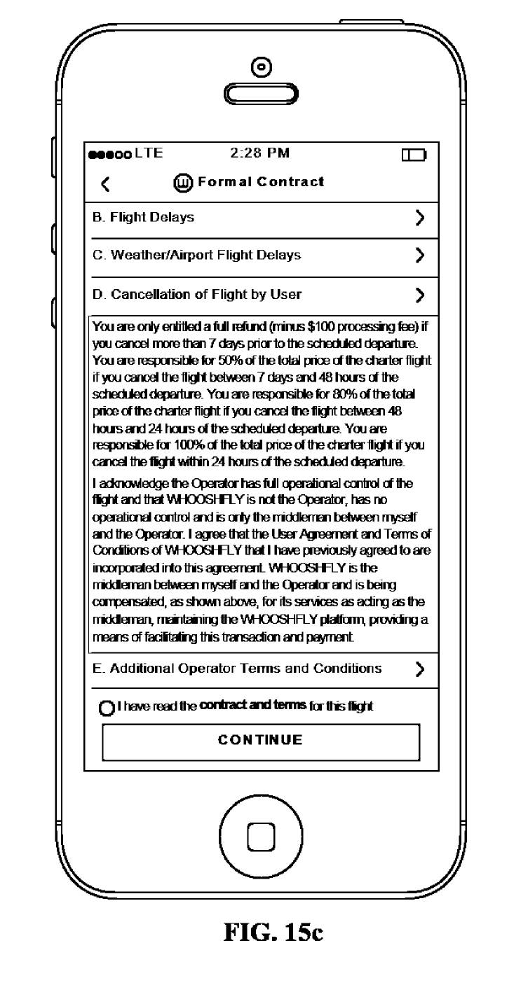

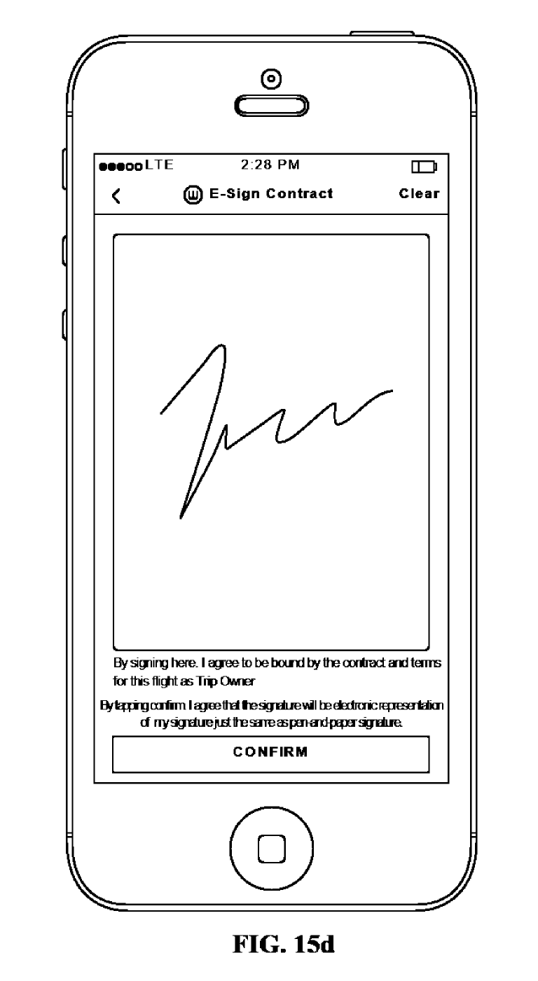

Referring to FIG. 13, an exemplary illustration of a screenshot of additional details, in accordance with one embodiment of the present invention. When a bid meets the user's requirements, the user is enabled to select the Bid. Referring to FIG. 14, an exemplary illustration of a screenshot of a payment screen, in accordance with one embodiment of the present invention. Referring to FIGS. 15a, 15b, 15c, and 15d, an exemplary illustration of screenshots of contract agreement a user is required to sign prior to booking the flight, in accordance with one embodiment of the present invention.

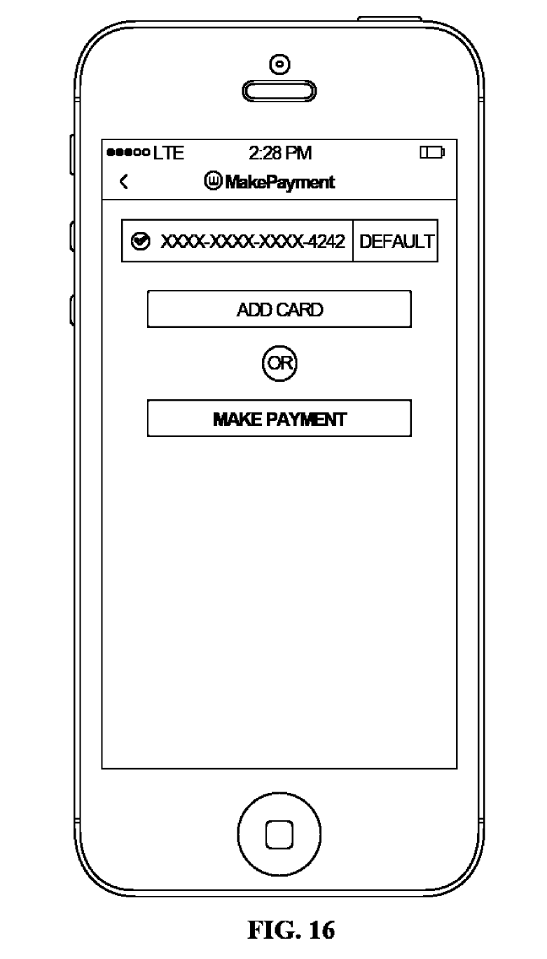

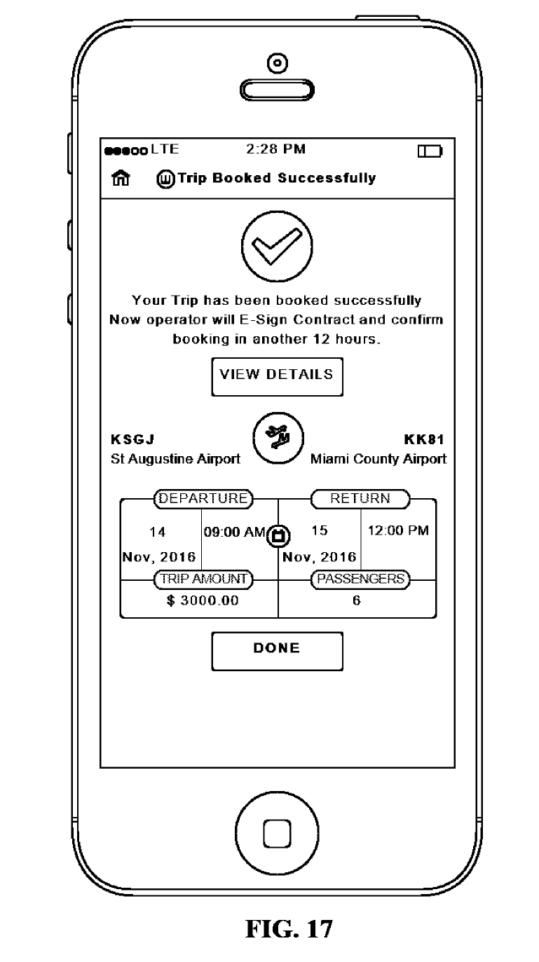

Referring to FIG. 16, an exemplary illustration of a screenshot of “make payment” page, in accordance with one embodiment of the present invention. After confirming and signing a contract, a user is enabled to pay for the user's trip using available payment methods such as credit cards. Referring to FIG. 17, an exemplary illustration of a screenshot of confirmation screen for trip, in accordance with one embodiment of the present invention. When a contract is signed and payment is processed, a success screen appears to a user.

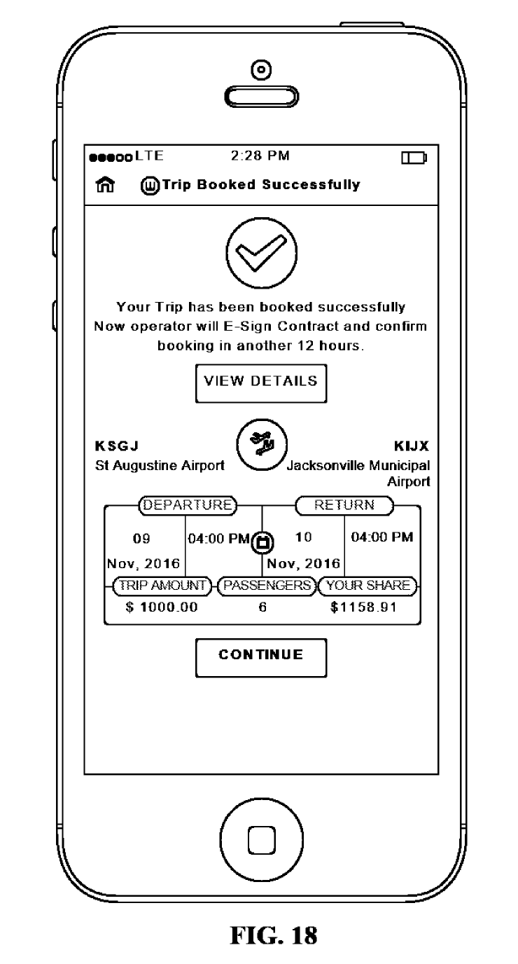

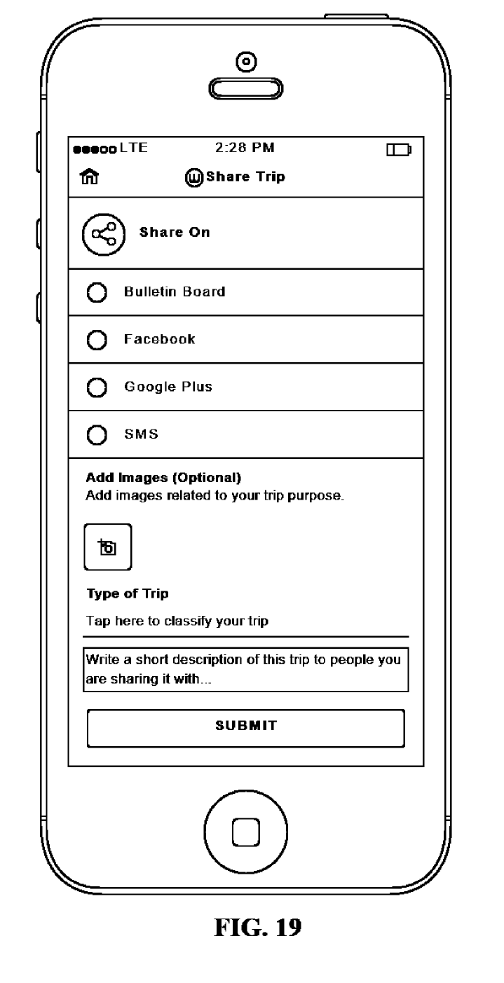

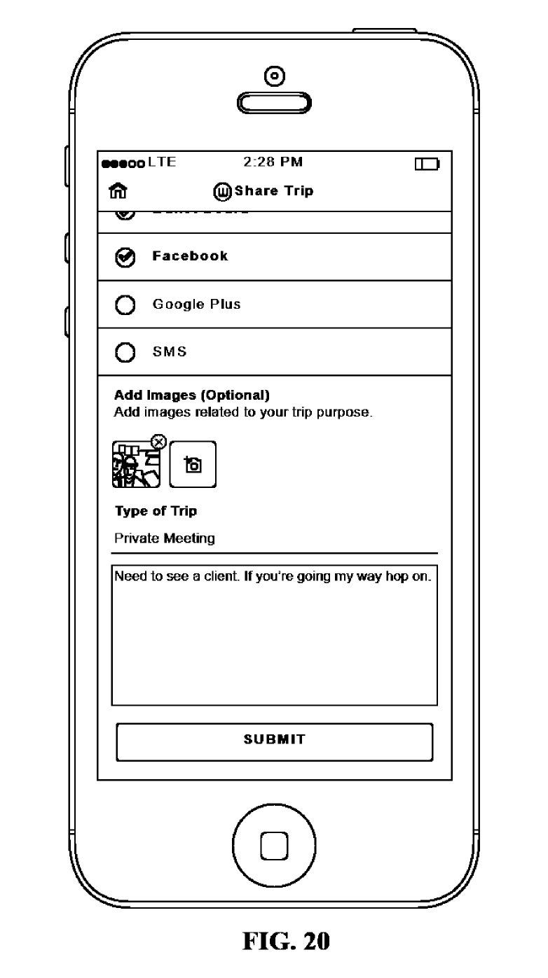

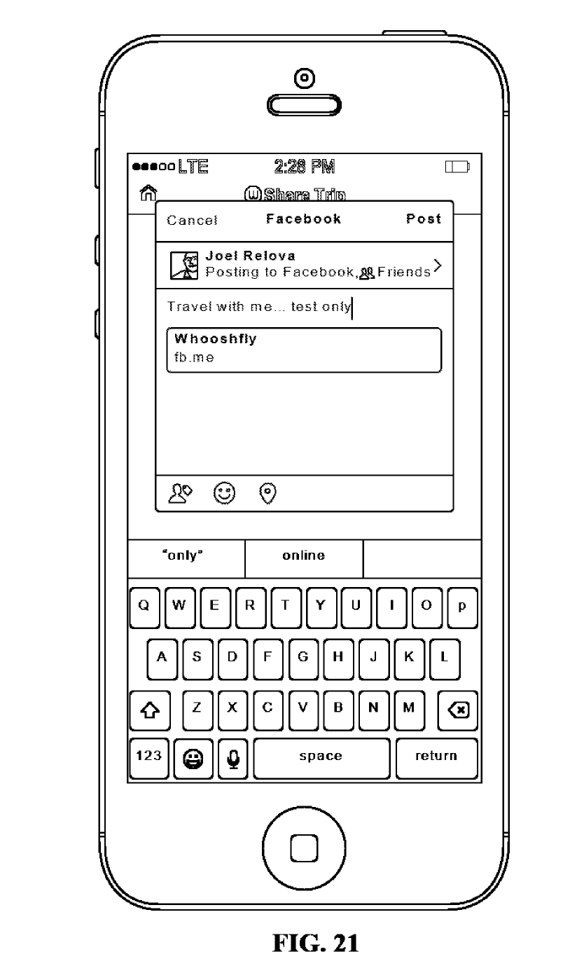

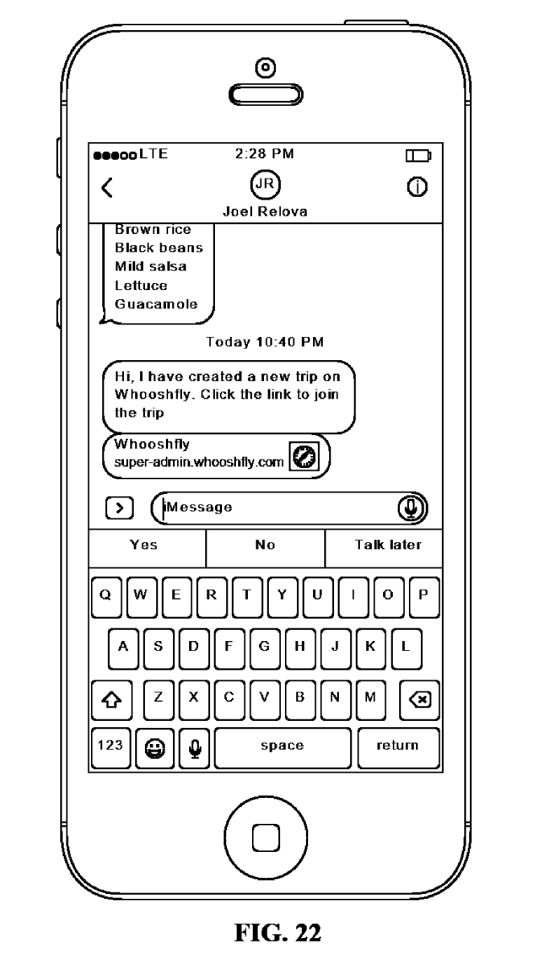

Referring to FIG. 18, an exemplary illustration of a screenshot of settings page for a committed flight share, in accordance with one embodiment of the present invention. In the committed flight share, a user goes through process of entering private plane charter request, then a flight booking component send the request to available Part 135 Charter the flight operators in the user's area. The user selecting best quote goes through process of booking the flight. Referring to FIG. 19, an exemplary illustration of a screenshot of socializing page, in accordance with one embodiment of the present invention. A user will have an option to “socialize” a flight to the user's network on one or more social media platforms. Referring to FIG. 20, an exemplary illustration of a screenshot of another socializing page, in accordance with one embodiment of the present invention. The user can also put in context to describe a flight. Referring to FIG. 21, an exemplary illustration of a screenshot of FACEBOOK™ integration, in accordance with one embodiment of the present invention. Referring to FIG. 22, an exemplary illustration of a screenshot of SMS integration, in accordance with one embodiment of the present invention.

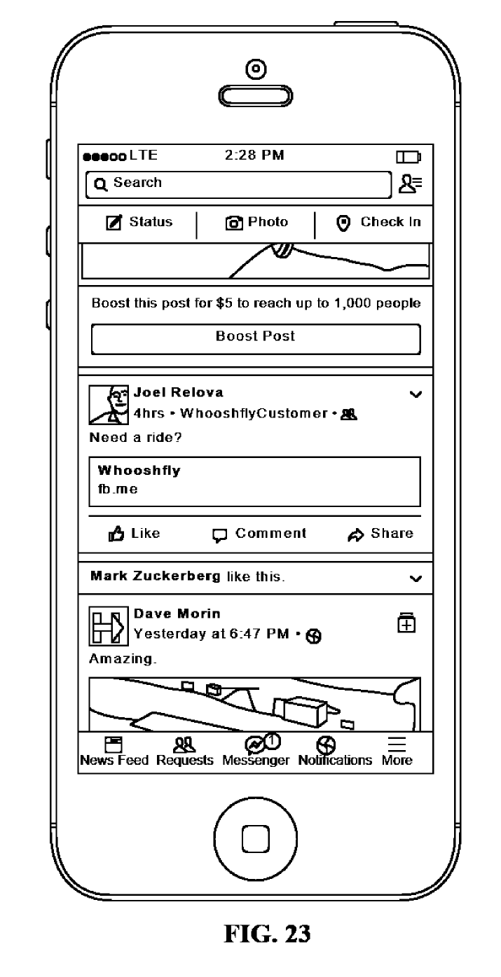

Referring to FIG. 23, an exemplary illustration of another screenshot of social media integration, in accordance with one embodiment of the present invention. After submission of the request to a social media platform, a user's friends and colleagues will see the user's request appear on the social media platform, posts describing the user's private chartered trip. The user's friends and colleagues will be able to click on the request to accept the invitation.

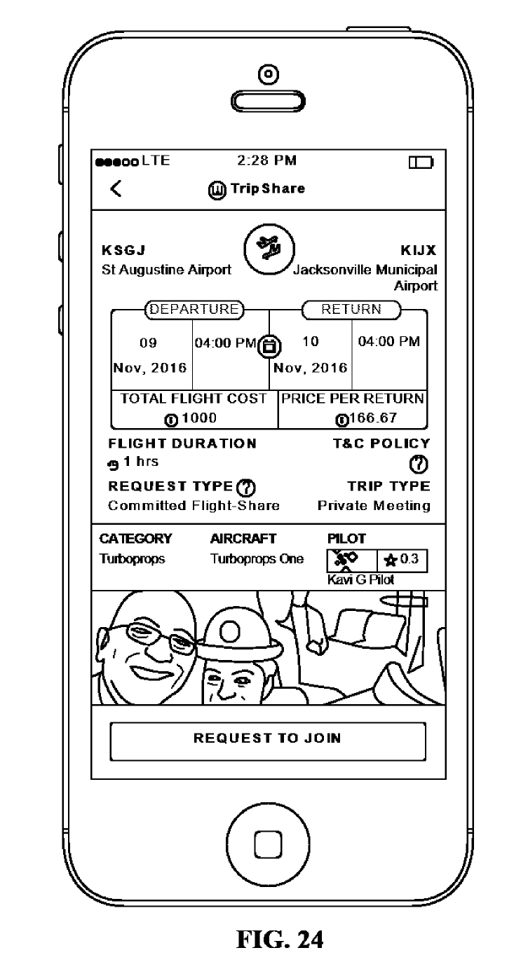

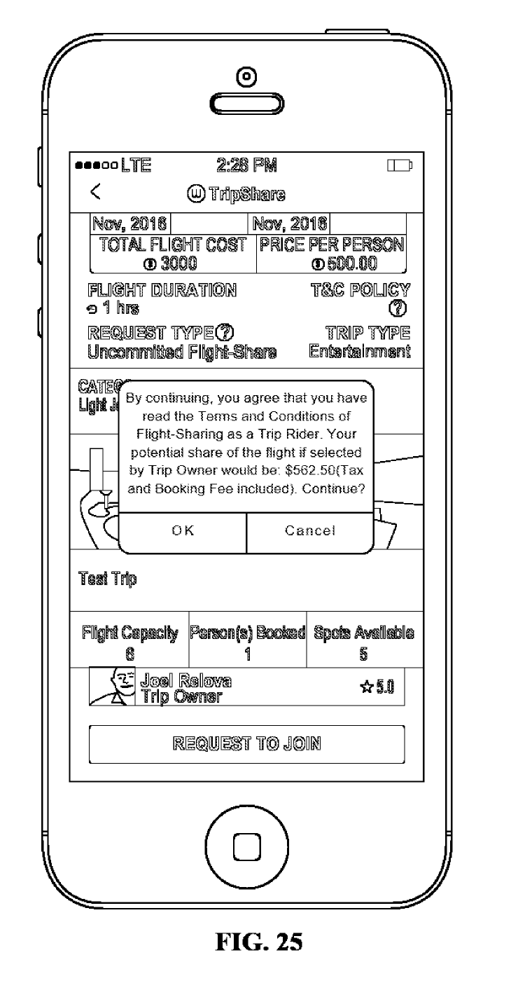

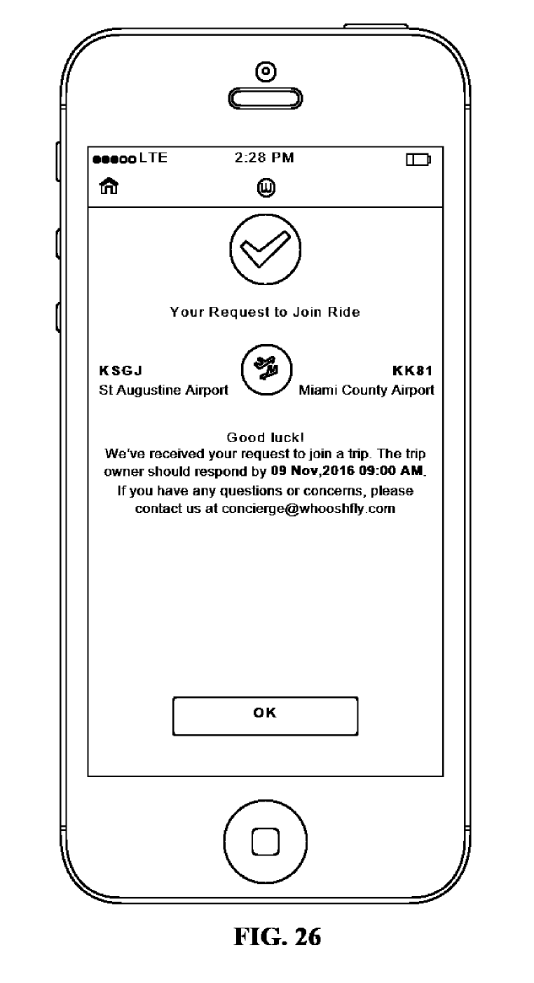

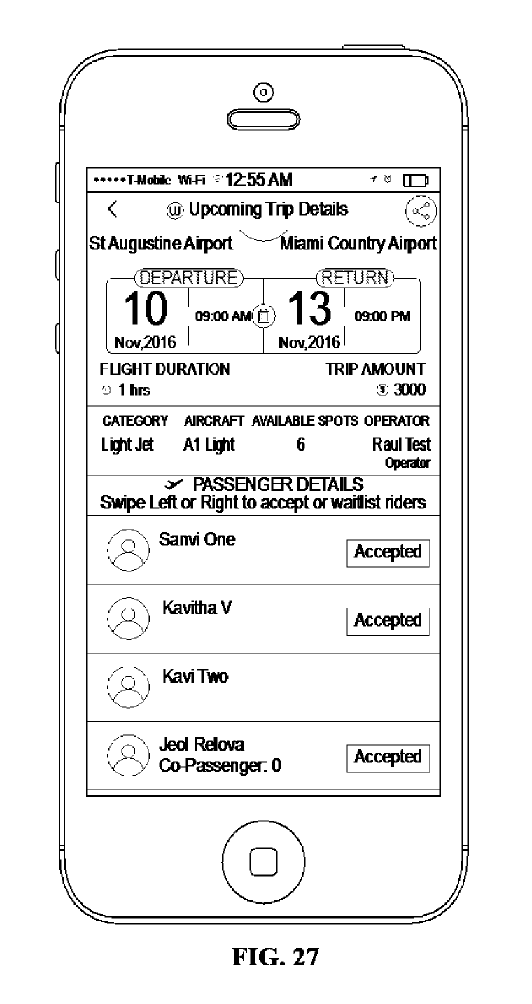

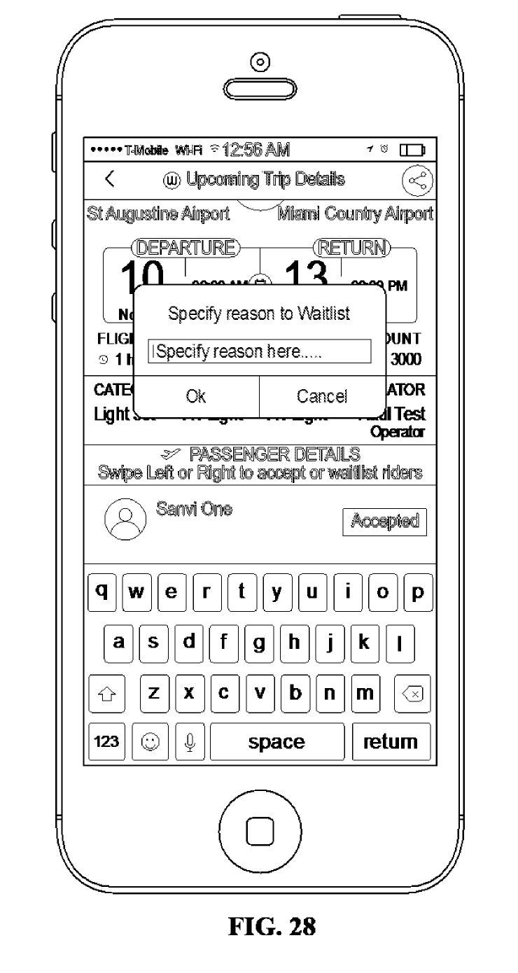

Referring to FIG. 24, an exemplary illustration of yet another screenshot of social media integration, in accordance with one embodiment of the present invention. The present invention brings an invited person directly to a screen describing details of a flight booked by the user. The invited person will have option to join the flight. Referring to FIG. 25, an exemplary illustration of a rules page, in accordance with one embodiment of the present invention. An invited person will be subject to certain rules and conditions upon continuing with the request, and the rules page displays the rules and conditions. Referring to FIG. 26, an exemplary illustration of a confirmation page, in accordance with one embodiment of the present invention. The confirmation page denotes that an invited person's request to join flight has been sent to a user. Referring to FIG. 27, an exemplary illustration of a notification page, in accordance with one embodiment of the present invention. The user will be notified every time an interested party wants to join a flight. The user will be provided a method to view all interested parties and will have the ability to either “Accept” a party or “Decline or Waitlist” a party. Referring to FIG. 28, an exemplary illustration of a waitlist page, in accordance with one embodiment of the present invention. The user is enabled to enter a reason on why the user is wait listing a party.

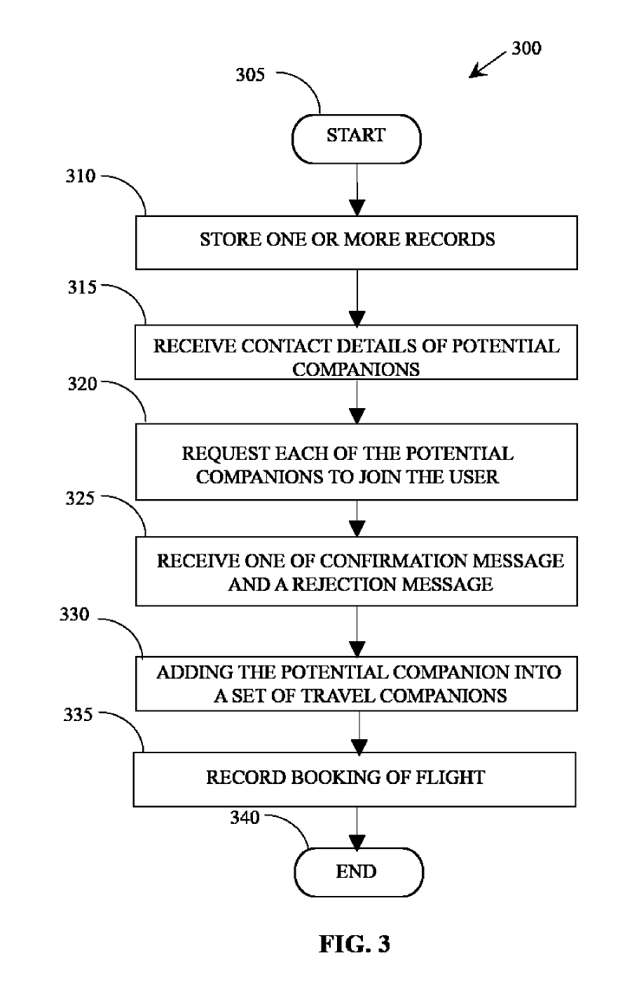

Referring to FIG. 3, is flow chart illustrating a computer-implemented method 300 of chartering a flight, according to yet another embodiment of the present invention. The method 300 is implemented in an environment in accordance with which various embodiments of the present invention are implemented. The environment comprises a first user device, a second user device, a network 235, and a server. The first user device and the second user device are at least one of tablet computers, personal computers, smart phones, smart televisions and laptops. In one embodiment of the present invention, the first user device and the second user device comprises a Global Positioning System (not shown here). In one example, the first user device enables a user to communicate with the server via the network. The second user device enables the workout buddy to communicate with the server via the network. The first user device and the second user device are at least one of laptops, personal computers, smart phones, smart televisions, and tablet computers. The server comprises a memory unit and a flight booking component.

The flight booking component is implemented inside a device connected to a network. The flight booking component is hereafter referred to as a processor. In one embodiment of the present invention, the device is a server. In another embodiment of the present invention, the device is at least one of a laptop, a personal computer, a smart phone, a smart television, and a tablet computer. The network is at least one of a Local Area Network, a Wide Area Network, a Wireless Network, a telecommunication network, a mobile network, and Internet. The network enables the user to communicate with the device. The user is connected to the network via a user terminal. The user terminal is at least one of a laptop, a personal computer, a smart phone, a smart television, and a tablet computer. The user terminal comprises a global positioning system (not shown).

Further, the device comprises a memory unit and the flight booking component. The memory unit is at least one of a volatile memory, non-volatile memory, Read Only memory (ROM), Random Access Memory (RAM), and a flash memory. The memory unit comprises a database of one or more records. The method 300 commences at step 305.

At step 310, the memory unit stores the database comprising one or more records associated with at least one user, and a set of program modules. The one or more records comprise details regarding at least one flight booked by the at least one user, capacity of the at least one flight, and details regarding at least one social media platform used by the user. The details regarding the at least one flight comprises time of arrival of the at least one flight, time of departure of the at least one flight, source airport of the at least one flight, and destination airport of the at least one flight. The social media platform is at least one of a travel based social media platform, a recreational social media platform, a forum based social media platform, and a professional social media platform. The set of program modules comprises an input module, a companion selection module, and an output module.

At step 315, the input module, executed by a processor, receives contact details of a set of potential companion travellers from the at least one social media platform, wherein the set of potential companion travellers are connected to the at least one user via the at least one social media platform.

At step 320, the companion selection module, requests at least one potential companion among the set of potential companions to join the at least one user on a journey in the at least one flight.

At step 325, the companion selection module receives from the at least one potential companion, at least one of a confirmation message and a rejection message from the at least one potential companion. The confirmation message implies willingness of the at least one potential companion to join the at least one user.

At step 330, the companion selection module adds the at least one potential companion into a set of travel companions, based on the confirmation message being received from the at least one potential companion. In one embodiment of the present invention, the companion selection module is further configured to compare number of people in the set of travel companions with the flight capacity of the at least one flight, and record booking of the at least one flight based on the number of people in the set of travel companions being equal to the flight capacity. The companion selection module requests the at least one potential companion via at least one of an email, a phone call, and a text message.

At step 335, the output module is configured to present the at least one user with the set of travel companions, and record booking of the at least one flight by the at least one user. The output module presents the at least one user with the set of travel companions via at least one of a laptop, a tablet computer, and a personal computer.

The method 300 ends at step 340.

Advantageously, the present invention provides users with ability to request for private chartered flight from a network of flight operators. The present invention automates process of submitting user's request to available flight operators, and also automates process of accepting bids from a plurality of participating flight operators, booking the flight and processing payment. In addition, the present invention provides the users with options to share the trip with other people, thereby making ordeal of chartering flights affordable and convenient. Further, the present invention enables the users to find like-minded people to share journeys and split costs with. The present invention operates in a multi stakeholder environment and enables passengers, private jet operators and pilots to come together to make private aviation accessible by everyone.

It will be appreciated by persons skilled in the art that the present invention is not limited to what has been particularly shown and described hereinabove. In addition, unless mention was made above to the contrary, it should be noted that all of the accompanying drawings are not to scale. A variety of modifications and variations are possible in light of the above teachings without departing from the following claims.

What is claimed is:

1. A system for chartering flights, the system comprising:
a memory unit to store:
a database comprising one or more records associated with at least one user, and
a set of program modules,
wherein the one or more records comprise details regarding at least one flight booked by the at least one user, capacity of the at least one flight, and details regarding at least one social media platform used by the user;
a processor to execute the set of program modules, wherein the set of program modules comprise:
an input module, executed by the processor, configured to receive contact details of a set of potential companion travellers from the at least one social media platform, wherein the set of potential companion travellers are connected to the at least one user via the at least one social media platform;
a companion selection module, executed by the processor, configured to:
request at least one potential companion among the set of potential companions to join the at least one user on a journey in the at least one flight,
receive from the at least one potential companion, at least one of a confirmation message and a rejection message to join the at least one user, and
add the at least one potential companion into a set of travel companions, based on the confirmation message being received from the at least one potential companion; and
an output module, executed by the processor, configured to:
present the at least one user with the set of travel companions, and
record booking of the at least one flight by the at least one user.

2. The system of claim 1, wherein the companion selection module is further configured to:
compare number of people in the set of travel companions with the flight capacity of the at least one flight, and
record booking of the at least one flight based on the number of people in the set of travel companions being equal to the flight capacity.

3. The system of claim 1, wherein the details regarding the at least one flight comprises time of arrival of the at least one flight, time of departure of the at least one flight, source airport of the at least one flight, and destination airport of the at least one flight.

4. The system of claim 1, wherein the social media platform is at least one of a travel based social media platform, a recreational social media platform, a forum based social media platform, and a professional social media platform.

5. The system of claim 1, wherein the companion selection module requests the at least one potential companion via at least one of an email, a phone call, and a text message.

6. The system of claim 1, wherein the output module presents the at least one user with the set of travel companions via at least one of a laptop, a tablet computer, and a personal computer.

7. A method of chartering flights, the system comprising:
storing in a memory unit, a database comprising one or more records associated with at least one user, wherein the one or more records comprise details regarding at least one flight booked by the at least one user, capacity of the at least one flight, and details regarding at least one social media platform used by the user;
receiving by a processor, via an input module, contact details of a set of potential companion travellers from the at least one social media platform, wherein the set of potential companion travellers are connected to the at least one user via the at least one social media platform;
requesting by the processor, via a companion selection module, at least one potential companion among the set of potential companions to join the at least one user on a journey in the at least one flight,
receiving by the processor, via the companion selection module, from the at least one potential companion, at least one of a confirmation message and a rejection message to join the at least one user,
adding by the processor, via the companion selection module, the at least one potential companion into a set of travel companions, based on the confirmation message being received from the at least one potential companion; and
presenting, by the processor via an output module, the at least one user with the set of travel companions, and
recording by the processor via the output module, booking of the at least one flight by the at least one user.

8. The method of claim 7, wherein the companion selection module is further configured to:
compare number of people in the set of travel companions with the flight capacity of the at least one flight, and
record booking of the at least one flight based on the number of people in the set of travel companions being equal to the flight capacity.

9. The method of claim 7, wherein the details regarding the at least one flight comprises time of arrival of the at least one flight, time of departure of the at least one flight, source airport of the at least one flight, and destination airport of the at least one flight.

10. The method of claim 7, wherein the social media platform is at least one of a travel based social media platform, a recreational social media platform, a forum based social media platform, and a professional social media platform.

11. The method of claim 7, wherein the companion selection module requests the at least one potential companion via at least one of an email, a phone call, and a text message.

12. The method of claim 7, wherein the output module presents the at least one user with the set of travel companions via at least one of a laptop, a tablet computer, and a personal computer.
